(19) United States
(12) Patent Application Publication
(10) Pub. No.: US 2019/0278046 A1
(43) Pub. Date: Sep. 12, 2019

(54) LENS UNIT AND IMAGING DEVICE

(71) Applicant: Nidec Corporation, Kyoto (JP)

(72) Inventor: Akinori YAMAMOTO, Kyoto (JP)

(21) Appl. No.: 16/337,420

(22) PCT Filed: Sep. 27, 2017
(86) PCT No.: PCT/JP2017/035010

§ 371 Date: Mar. 28, 2019

(30) Foreign Application Priority Data
Sep. 30, 2016 (JP) 2016-192418

(51) Int. Cl. G02B 7/02; H04N 5/225; G02B 9/64

(52) U.S. Cl. CPC G02B 7/021; G02B 9/64; H04N 5/2254

(57) ABSTRACT

A lens unit includes lenses arranged along an optical axis, and a support that supports the lenses. The lenses include a negative lens made of resin and having a negative power and a positive lens made of resin and having a positive power. A distance between two lens surfaces of the negative lens is minimum on the optical axis. A buffer layer and an antireflection layer are successively provided on at least one lens surface of the two lens surfaces of the negative lens. The antireflection layer is provided directly on at least one lens surface of two lens surfaces of the positive lens.

### 1. FIELD OF THE DISCLOSURE

The present disclosure relates to a lens unit including a plurality of lenses, and an imaging device including the lens unit.

### 2. BACKGROUND

To date, antireflection films have been provided for lenses of lens units used for various purposes. In a related-art zoom lens system, a positive meniscus lens disposed on an image side in a first lens group is a plastic lens. In the plastic lens, an underlayer that is a mixture of Al₂O₃ and La₂O₃ is formed. An antireflection film is formed on the underlayer. As a result, stress generated in the antireflection film is relaxed, and peeling and cracks are prevented from occurring.

In the related-art optical component, an intermediate layer, which is a binder layer, is provided between an optical resin substrate and an optical thin film layer, which is an antireflection film. As a result, this prevents damage or peeling of the antireflection film due to a difference in thermal expansion coefficient between the optical resin substrate and the antireflection film in a reflow process at 250° C. or higher.

If a buffer layer is provided between an antireflection film and a lens surface for all lens surfaces adjacent to air layers among all resin lenses of the lens unit, the manufacturing cost of the lens unit is increased. However, the relationship between the omission of the buffer layer and the image quality obtained through the lens unit has never been considered.

### SUMMARY

Example embodiments of the present disclosure reduce manufacturing costs of lens units while suppressing deterioration of image quality.

A lens unit according to an example embodiment of the present disclosure includes a plurality of lenses arranged along an optical axis, and a support that supports the plurality of lenses. The plurality of lenses include a negative lens made of resin and having a negative power and a positive lens made of resin and having a positive power. A distance between two lens surfaces of the negative lens is minimum on the optical axis. A buffer layer and an antireflection layer are successively provided on at least one lens surface of the two lens surfaces of the negative lens. The antireflection layer is provided directly on at least one lens surface of two lens surfaces of the positive lens.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a sectional view of an imaging device according to a first example embodiment of the present disclosure.

FIG. 2 is an enlarged view of a vicinity of a lens surface on an object side of a second lens.

FIG. 3 is an enlarged view of a vicinity of a lens surface on an image side of the second lens.

FIG. 4 is a sectional view of an imaging device according to a second example embodiment of the present disclosure.

### DETAILED DESCRIPTION

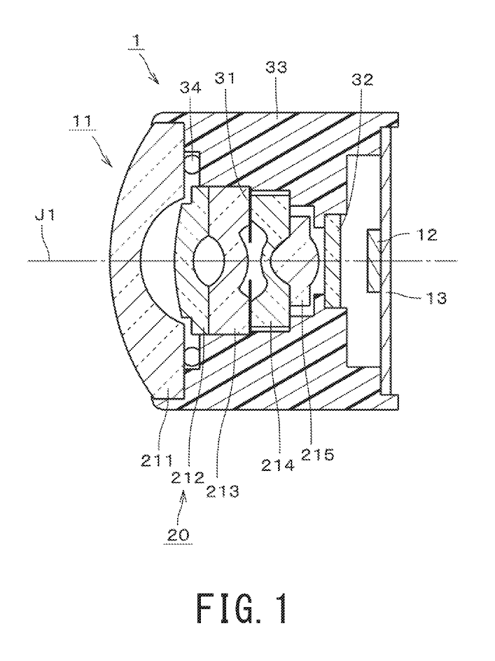

FIG. 1 is a sectional view of an imaging device 1 according to a first exemplary embodiment of the present disclosure. The imaging device 1 includes a lens unit 11, an imaging element 12, and a circuit board 13. The lens unit 11 includes a plurality of lenses 20, an aperture 31, an infrared filter 32, and a support portion 33. In the present example embodiment, the plurality of lenses 20 include a first lens 211, a second lens 212, a third lens 213, a fourth lens 214, and a fifth lens 215. “Lens” in the following description is a member functioning as a lens, that is, a lens member in which a layer having a desired function is formed on a lens surface of a lens body as required. The layer on the lens surface is a thin film. In addition, a lens having a negative power is called a “negative lens”, and a lens having a positive power is called a “positive lens”. The plurality of lenses 20 are arranged along an optical axis J1.

The support portion 33 is a holder that supports the plurality of lenses 20, the aperture 31, and the infrared filter 32. The support portion 33 is also called “lens barrel” or “barrel”. In the present example embodiment, the support portion 33 is made of resin, but is not limited to resin. The first lens 211, the second lens 212, the third lens 213, the aperture 31, the fourth lens 214, the fifth lens 215, and the infrared filter 32 are arranged in this order from an object side to an image side along the optical axis J1. That is, these constituent elements are located on the optical axis J1 in this order. The circuit board 13 is attached to the support portion 33 on the image side of the infrared filter 32. The imaging element 12 is mounted on the circuit board 13. The imaging element 12 is located on the image side of the lens unit 11. An image is formed on the imaging element 12 by the lens unit 11. The imaging element 12 is a two-dimensional image sensor.

The first lens 211 is fixed to the support portion 33 by caulking. A seal member 34 is disposed between the first lens 211 and the support portion 33. The seal member 34 is, for example, an O ring. The opening on the object side of the support portion 33, which has a cylindrical shape, is hermetically sealed by the first lens 211 and the seal member 34. The second lens 212, the third lens 213, the aperture 31, and the infrared filter 32 are press-fitted into the support portion 33. The fourth lens 214 and the fifth lens 215 are cemented lenses joined by an adhesive. The cemented lenses are press-fitted in the support portion 33. The expression “are press-fitted” is synonymous with “are in a press-fitted state”.

The first lens 211 is made of glass. The second lens 212, the third lens 213, the fourth lens 214, and the fifth lens 215 are made of resin. The first lens 211 and the second lens 212 are negative meniscus lenses convex toward the object side. The third lens 213 is a negative meniscus lens convex toward the image side. The fourth lens 214 is a negative meniscus lens convex toward the object side. The fifth lens 215 is a biconvex positive lens.

An antireflection layer is directly formed on a lens surface on an object side of the first lens 211. A water repellent layer or another functional layer may or may not be provided on the antireflection layer. On a lens surface on an image side of the first lens 211, only the antireflection layer is directly formed. In the following description, “a layer is formed” is synonymous with “a layer is present”.

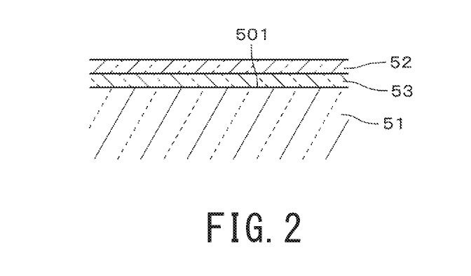

FIG. 2 is an enlarged view illustrating the vicinity of a lens surface 501 on the object side of the second lens 212. More precisely, the lens surface 501 is a curved surface, but in FIG. 2 it is illustrated as a straight line. On the lens surface 501, that is, on a lens body 51, which is made of resin, a buffer layer 53 is directly formed. An antireflection layer 52 is formed on the buffer layer 53. The buffer layer 53 reduces stress generated in the antireflection layer 52 due to a difference in coefficient of thermal expansion between the lens body 51, which is a resin, and the antireflection layer 52. As a result, the occurrence of cracks in the antireflection layer 52 is prevented.

In the present specification, the coefficient of thermal expansion refers to the linear expansion coefficient. In addition, “crack” in the antireflection layer refers to damage such as fine cracks or fine peeling that occurs in the antireflection layer.

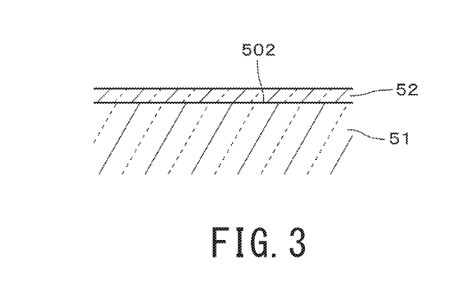

FIG. 3 is an enlarged view of the vicinity of a lens surface 502 on the image side of the second lens 212. More precisely, the lens surface 502 is a curved surface, but in FIG. 3 it is illustrated as a straight line. On the lens surface 502, only the antireflection layer 52 is directly formed.

Only the antireflection layer is directly formed on the lens surfaces on the object side and image side of the third lens 213. On a lens surface on the object side of the fourth lens 214, only the antireflection layer is directly formed. A lens surface on the image side of the fourth lens 214 and a lens surface on the object side of the fifth lens 215 are joined to each other with an adhesive. On a lens surface on the image side of the fifth lens 215, only the antireflection layer is directly formed.

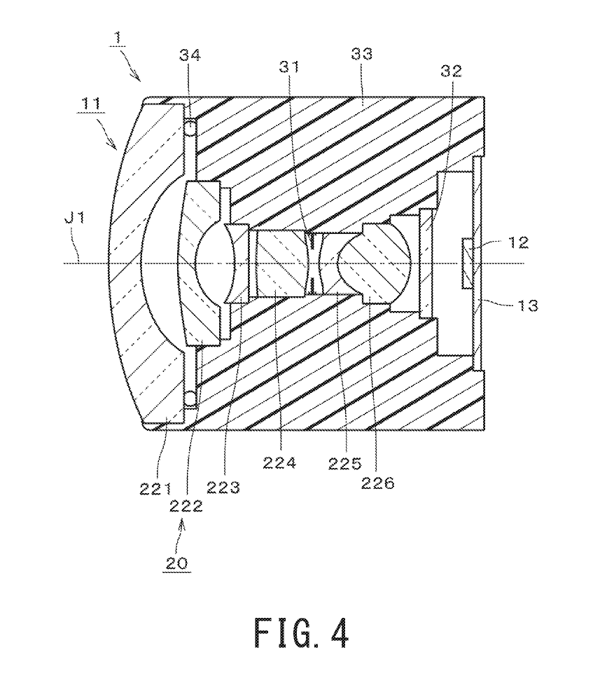

FIG. 4 is a sectional view of the imaging device 1 according to a second exemplary embodiment of the present disclosure. In FIG. 4, with the exception of each lens, the same reference numerals are given to constituent elements having the same functions as those illustrated in FIG. 1. The basic structure of the imaging device 1 illustrated in FIG. 4 is the same as that illustrated in FIG. 1, except that the number of the plurality of lenses 20 of the lens unit 11 is six. The plurality of lenses 20 include a first lens 221, a second lens 222, a third lens 223, a fourth lens 224, a fifth lens 225, and a sixth lens 226.

The first lens 221, the second lens 222, the third lens 223, the fourth lens 224, the aperture 31, the fifth lens 225, the sixth lens 226, and the infrared filter 32 are disposed along the optical axis J1 from the object side to the image side in this order.

The first lens 221 is fixed to the support portion 33 by caulking. The seal member 34 is disposed between the first lens 221 and the support portion 33. The second lens 222, the third lens 223, the fourth lens 224, and the infrared filter 32 are press-fitted into the support portion 33. The aperture 31 is fitted and fixed in the support portion 33 by utilizing minute protrusions formed on the inner peripheral surface of the support portion 33. The fifth lens 225 and the sixth lens 226 are cemented lenses joined to each other with an adhesive, and the cemented lenses are press-fitted into the support portion 33.

The first lens 221 is made of glass. The second lens 222, the third lens 223, the fourth lens 224, the fifth lens 225, and the sixth lens 226 are made of resin. The fourth lens 224 may be made of glass. The first lens 221 and the second lens 222 are negative meniscus lenses that are convex toward the object side. The third lens 223 is a negative meniscus lens that is convex toward the image side. The fourth lens 224 is a biconvex positive lens. The fifth lens 225 is a negative meniscus lens convex toward the object side. The sixth lens 226 is a biconvex positive lens.

An antireflection layer is formed directly on a lens surface on the object-side of the first lens 221. A water repellent layer or another functional layer may or may not be provided on the antireflection layer. On a lens surface on the image side of the first lens 221, only an antireflection layer is directly formed. On a lens surface on the object side of the second lens 222, a buffer layer is directly formed. An antireflection layer is formed on the buffer layer. On a lens surface on the image side of the second lens 222, only an antireflection layer is directly formed. The buffer layer prevents cracks from occurring in the antireflection layer on the lens surface on the object-side of the second lens 222 as in the first example embodiment.

Only an antireflection layer is directly formed on lens surfaces on the object side and image side of the third lens 223 and the fourth lens 224. On a lens surface on the object side of the fifth lens 225, only an antireflection layer is directly formed. A lens surface on the image side of the fifth lens 225 and a lens surface on the object side of the sixth lens 226 are joined to each other with an adhesive. On a lens surface on the image side of the sixth lens 226, only an antireflection layer is directly formed.

If buffer layers are provided on all the lens surfaces of all the resin lenses in the above two example embodiments, the manufacturing cost of the lens unit 11 increases. Here, with each of the negative lenses, the distance between the lens surfaces on the optical axis J1 is the smallest. More precisely, in the negative lens, the thickness of the portion functioning as a lens is smallest on the optical axis J1, and within the portion functioning as a lens, the outer peripheral portion is thick. Therefore, in the case of the negative lens, when the temperature rises, the outer peripheral portion tends to expand greatly and a large stress is generated in the center.

On the other hand, in each of the positive lenses, the thickness of the portion functioning as a lens is largest on the optical axis J1, and within the portion functioning as a lens, the outer peripheral portion is thin. Therefore, in the positive lens, the stress caused by a temperature rise is relatively small as compared with the negative lens. As a result, when the antireflection layer is directly provided on the lens surface, there is a higher probability that cracks are generated in the antireflection layer in the negative lenses rather than the positive lenses. From this, it can be said that in order to reduce the manufacturing cost of the lens unit 11, it is preferable to omit the buffer layer in any one of the positive lenses. Of course, even in the negative lenses, if it is possible to omit the buffer layer then it can be omitted.

Generally speaking, in the lens unit 11, it is preferable that a buffer layer and an antireflection layer be present successively on at least one lens surface of two lens surfaces of any one of the negative lenses, and an antireflection layer be present directly on at least one lens surface of two lens surfaces of any one of the positive lenses. Thereby, it is possible to reduce the manufacturing cost of the lens unit 11 while suppressing deterioration of image quality. The lens surface on which the antireflection layer is provided is a lens surface adjacent to the air layer. More preferably, an antireflection layer exists directly on all the lens surfaces adjacent to air layers among the lens surfaces of all the positive resin lenses having a positive power included in the plurality of lenses 20. Thereby, the manufacturing cost of the lens unit 11 can be further reduced.

Here, the negative lens is a negative meniscus lens, a biconcave lens, or a plano-concave lens. The positive lens is a positive meniscus lens, a biconvex lens, or a plano-convex lens.

In the negative lens, the characteristic that the stress generated due to the temperature rise is larger than that in the positive lens is marked when the outer periphery of the lens is held by the support portion 33. Furthermore, this becomes more prominent in the case where the thermal expansion coefficient of the resin material of the negative lens is larger than the thermal expansion coefficient of the support portion 33, in the case where the entire outer periphery of the negative lens is held by the support portion 33, in the case where the negative lens is press-fitted into the support portion 33, and in the case where the negative lens is a meniscus lens.

In the lens unit 11, which is small, normally, when the number of the plurality of lenses 20 is five, six or seven, the second lens from the object side is the lens closest to the object side among the resin lenses. Therefore, deterioration of the second lens most affects image quality. Therefore, in the case where the second lens from the object side is a negative resin lens, it is preferable that a buffer layer and an antireflection layer be present in this order on at least one lens surface of this lens, and it is preferable that an antireflection layer be present directly on the lens surface of the other negative lenses and positive lenses.

Furthermore, because a lens surface on the object side of the second lens influences the image quality more than a lens surface on the image side, in the above embodiment, the buffer layer and the antireflection layer exist successively only on the lens surface on the object side of the second lenses 212, 222. In addition, an antireflection layer is present directly on the lens surface on the image side of the second lenses 212, 222. As a result, it is possible to greatly reduce the manufacturing cost of the lens unit 11 while suppressing deterioration of the quality of the acquired image. Of course, a buffer layer may also be provided between the lens surface on the image side of the second lenses 212, 222 and the antireflection layer. Furthermore, the buffer layer and the antireflection layer may be present successively on all the lens surfaces adjacent to air layers of all the negative resin lenses.

Next, a concrete example of the second lens and heat resistance test will be described. In this specific example, a lens unit similar to that of the first example embodiment is assumed; however, a buffer layer and an antireflection layer are formed successively on both lens surfaces of the second lens.

As the resin of the lens body of the second lens, ARTON (registered trademark) manufactured by JSR Corporation was used. The diameter of the lens surface on the object side when viewed along the optical axis was 5.4 mm, the diameter of the lens surface on the image side was 2.3 mm, and the center thickness was 0.9 mm. The lens body was a meniscus lens having a negative power. The lens body was manufactured by injection molding.

As the resin material of the lens body, any of various materials can be used. For example, amorphous polyolefin resin, polycarbonate resin, or acrylic resin can be used. The same applies to the other lenses made of resin.

As a coating solution for the buffer layer, a solution prepared by mixing amorphous silica, an acrylic resin, a photopolymerization initiator, and a solvent containing PGM (propylene glycol monomethyl ether) as a main component at a desired ratio was prepared. The coating solution was applied to the lens surface on the object side of the lens body by a spin coating method, and the coating solution was irradiated with ultraviolet rays having an accumulated light amount of 15000 mJ/cm² to cure the coating solution. Thereafter, the same operation was performed on the lens surface on the image side of the lens body. A buffer layer having a thickness of 3 μm was formed on both lens surfaces.

The thickness of the buffer layer is preferably 1 μm or more and 3 μm or less. When the thickness of the buffer layer is 1 μm or less, a buffering effect decreases. When the thickness of the buffer layer is 3 μm or more, uneven coating tends to occur.

The design wavelength λ of the antireflection layer was 500 nm. The antireflection layer was formed by stacking thin films of silicon dioxide (18.1 nm)/titanium oxide (15.0 nm)/silicon dioxide (31.2 nm)/titanium oxide (51.5 nm)/silicon dioxide (14.2 nm)/titanium oxide (35.9 nm)/silicon dioxide (91.8 nm) in order from the side close to the lens body. Here, the refractive index of silicon dioxide was about 1.46, and the refractive index of titanium oxide was about 2.38. However, because the refractive index slightly varies depending on the forming conditions, the film thickness was adjusted.

Next, an antireflection layer was appropriately formed as appropriate on the lens surfaces of the first lens and the third to fifth lenses similar to those in the first example embodiment. A lens unit similar to that of the first example embodiment was assembled using the first lens to the fifth lens, and a heat resistance test was performed.

In addition, a similar lens unit having no buffer layer on the second lens was manufactured as a comparative example, and a heat resistance test was performed.

In the heat resistance test, the lens unit was placed in an atmospheric air oven and the temperature was raised from 90° C. to 10° C. Cracks were observed in the antireflection layer after standing for 1000 hours at each temperature. The temperature at which cracks occurred was defined as the heat resistance temperature. The presence or absence of cracks was judged visually by using a microscope. The number of samples was set to three and the average of the three samples was taken as the final heat resistance temperature.

In the case of providing the buffer layer, the heat resistance temperature of the second lens was 120° C. On the other hand, in the comparative example without the buffer layer, the heat resistance temperature of the second lens was 90° C. As described above, the coefficient of thermal expansion of the resin and the antireflection layer are largely different, but as illustrated in the above heat resistance test, the occurrence of cracks in the antireflection layer at a high temperature is prevented by the buffer layer.

The antireflection layer is not limited to the above example, and various multilayered inorganic oxide films can be used. For example, when the antireflection layer has a three-layer structure, the thickness of each layer (hereinafter referred to as “element layer”) forming the antireflection layer is set to λ/4, the designed wavelength is set to λ, a structure in which the thickness of the first element layer close to the lens surface and the third element layer far from the lens surface is λ/4 and the thickness of the intermediate second element layer is λ/2 can be adopted. The design wavelength λ is preferably around 500 nm which is the center wavelength of visible light. As a material of the element layer, silicon oxide, titanium oxide, lanthanum titanate, tantalum oxide, niobium oxide or the like can be used. The transmittance of the resin lens is improved by the antireflection layer.

A heat resistance temperature of 120° C. is suitable for an in-vehicle imaging device. In particular, it is suitable in the case where the lens closest to the object side of the lens unit 11 or a protective member disposed outside the lens is exposed to the outside of the vehicle. Therefore, it is preferable that the lens unit 11 having a heat resistance temperature of 120° C. or higher be used for a sensing imaging device of high image quality for, for example, automatic driving. Needless to say, the lens unit 11 can also be used for simple monitoring.

Various modifications are possible in the imaging device 1 and the lens unit 11.

The number of lenses in the lens unit 11 is not limited to five to seven, and may be four or less, or eight or more. The first lenses 211, 221 may be made of resin. The optical axis J1 is not limited to a straight line and may be bent. It is not necessary for the support portion 33 to hold the whole outer periphery of the lens, and it may hold a portion of the outer periphery. The lens may be supported by the support portion 33 in a state where the lens is held by another holder.

In the above example embodiment, the buffer layer is present in direct contact with the lens surface, and the antireflection layer is present in direct contact with the buffer layer; however, as long as the buffer layer and the antireflection layer are present in this order on the lens surface, other layers may be present. The negative resin lens provided with the buffer layer and the antireflection layer may be a lens other than the second lens from the object side.

The fixing method of fixing the imaging element 12 to the lens unit 11 may be variously changed. The imaging device 1 may be used for purposes other than in vehicles.

The present disclosure is applicable to, for example, a lens unit of various applications and is suitable for a lens unit with a probability of being used in a high-temperature environment or of attaining a high temperature.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-6: (canceled)

7: A lens unit comprising:
a plurality of lenses disposed along an optical axis; and
a support that supports the plurality of lenses; wherein
the plurality of lenses include:
a negative lens made of resin and having a negative power; and
a positive lens made of resin and having a positive power; wherein
a distance between two lens surfaces of the negative lens is minimum on the optical axis;
a buffer layer and an antireflection layer are provided successively on at least one lens surface of the two lens surfaces of the negative lens; and
the antireflection layer is provided directly on at least one lens surface of two lens surfaces of the positive lens.

8: The lens unit according to claim 7, wherein the antireflection layer is provided directly on all lens surfaces adjacent to air layers among lens surfaces of all positive lenses made of resin and having the positive power included in the plurality of lenses.

9: The lens unit according to claim 7, wherein a number of the plurality of lenses is five to seven, and the negative lens is a second lens from an object side.

10: The lens unit according to claim 8, wherein a number of the plurality of lenses is five to seven, and the negative lens is a second lens from an object side.

11: The lens unit according to claim 9, wherein the buffer layer and the antireflection layer are provided successively on a lens surface on the object side of the negative lens.

12: The lens unit according to claim 10, wherein the buffer layer and the antireflection layer are provided successively on a lens surface on the object side of the negative lens.

13: The lens unit according to claim 11, wherein the antireflection layer is provided directly on a lens surface on an image side of the negative lens.

14: The lens unit according to claim 12, wherein the antireflection layer is provided directly on a lens surface on an image side of the negative lens.

15: An imaging device comprising:
the lens unit according to claim 7; and
an imaging element located on an image side of the lens unit.
